(19) United States
(12) Patent Application Publication
(10) Pub. No.: US 2012/0099188 A1
(43) Pub. Date: Apr. 26, 2012

(54) Laser Protection Structures and Methods of Fabrication

(75) Inventors: Neset Akozbek, Huntsville, AL (US); Milan Buncick, Huntsville, AL (US); Carlos Kengla, Madison, AL (US)

(73) Assignee: AEgis Technologies Group, Inc., Huntsville, AL (US)

(21) Appl. No.: 13/194,750

(22) Filed: Jul. 29, 2011

Related U.S. Application Data
(60) Provisional application No. 61/491,778, filed on May 31, 2011.
(60) Provisional application No. 61/405,082, filed on Oct. 20, 2010.

(51) Int. Cl. G02B 5/28; B05D 5/06

(52) U.S. Cl. 359/360; 359/585; 359/350; 427/164

(57) ABSTRACT

An optically transmissive structure for laser protection is provided including a plurality of metallic layers of material interspersed with a plurality of dielectric layers of material. The metallic layers are interposed with the dielectric layers; the metallic layers include individual layers each having a thickness smaller than a skin depth of the metal at a selected wavelength; and the dielectric layers separating two metallic layers have a thickness equal to or smaller than the selected wavelength in the dielectric layer of material. A method for fabricating the above structure is also provided. An optically transmissive structure for laser protection including a plurality of metal layers interposed with dielectric material layers is also provided. A transmittance of the structure is greater than fifty percent (50%) for an incident light having a wavelength of 550 nm; and an optical density of the structure is greater than two (2) for an incident light having a wavelength between 1000 nm and 1400 nm.

### CROSS-REFERENCE TO RELATED APPLICATIONS

This application relates and claims priority to U.S. Provisional Patent Application No. 61/405,082 filed Oct. 20, 2010, and Provisional Patent Application No. 61/491,778 filed May 31, 2011, each entitled “Broadband Wide Angle Laser Eye Protection Filters and Methods of Fabrication,” the disclosure of which is incorporated by reference, in its entirety here for all purposes.

### STATEMENT REGARDING FEDERALLY SPONSORED RESEARCH OR DEVELOPMENT

All or a portion of this invention was made with Government support under Contract #N68936-09-C-0096 awarded by NAVAIR, Contract #FA8650-09-M-6950 and/or Contract #FA8650-10-C-6107, each awarded by the Air Force. The Government has certain rights in the invention.

### BACKGROUND

1. Field of the Invention

Embodiments described in the present disclosure relate generally to the field of laser protection structures for eye and visible sensor applications and methods of fabricating the same. More specifically, embodiments disclosed herein relate to the field of multilayered thin film optical structures and methods of fabricating the same for laser eye protection.

2. Description of Related Art

Laser Protection (LP) structures and coatings are currently used in applications ranging from industrial operations to military deployments and research environments. Most laser eye protection devices are designed to protect against fixed laser wavelength lines. A common LP technology uses absorbing dyes. Dye-based LP filters are cost effective and may be injection molded into polycarbonate lenses. Thus, dye-based LPs can be used in various visor shapes. Also, dyes absorb light over a broad angle of incidence and thus provide omni-directional protection.

A drawback of absorbing dyes is the reduced transmittance in the visible wavelength range from approximately 400 nanometers (“nm”) to approximately 750 nm. The reduced transmittance is the result of wide absorption bands even for dyes that absorb in the infrared. This becomes an issue particularly when multiple laser lines are being absorbed. In this case, the visible transmittance of a dye may be as low as 20% or less. This low transmittance in the visible spectral range is not sufficient for using LP devices under low light or night time operations. The effect is analogous to wearing sunglasses. In addition to low visible transmittance, the wide absorption bands of dyes may cause color distortion. This may impact color discrimination and produce color distortion in colored avionics displays for example, degrading the visibility of the person wearing the LP. The above issues become more severe as protection against multiple wavelengths is used.

Another drawback of dyes is their chemical degradation over time, particularly by solar radiation. Moreover, dyes may not be effective against pulsed laser radiation having high peak power, due to absorption bleaching and saturation.

Another approach for fabricating LP structures and coatings is based on interference filters such as all dielectric multilayer coatings and rugate filters. Interference filters may be designed to filter out narrow laser lines, while providing high visible transmittance. Interference filters operate on the principle of reflecting or diffracting the incoming laser light, in contrast to absorbing dyes. To achieve this, typically a large number of layers (50 or even more) of dielectric material are stacked together. Thus, interference filters are costly, as each of the layer thicknesses is controlled with high precision. In addition, they are difficult to apply on a large area and on complex-shaped visors, especially for mass production.

Even if multilayer stacks are fabricated on single large visors, it would be difficult to achieve laser protection for both eyes. This is due to the dependence of the interference filter's spectral optical density on the angle of incidence of the light onto the multilayered structure. The optical density (OD) of a structure is defined as

OD=−log₁₀(T) (1)

where T is the linear transmission of the light, or transmittance:

T=I_{f}/I_{0,} (2)

with I₀ being the intensity of light impinging on the structure and I_{f} the intensity of the light leaving the structure after traversing it. The values of OD and T in Eqs. (1) and (2) are dependent on the wavelength of the light impinging on the structure. Thus, OD and T have a spectral variation.

At certain angles of incidence the multilayer LP does not maintain its protective characteristics. As an out-of-transmission band wavelength may shift towards an in-transmission band spectral region at an angle of incidence different from normal incidence 0°. In some limited cases such as goggles or spectacles, the angle of incidence limitation can be overcome by properly designing the lens geometry.

Other technology for LP structures and coatings is based on holographic filters which may be applied to complex shapes and larger areas. However, the performance of holographic filters depends on angle of incidence. Another drawback of holographic filters is that holograms are sensitive to moisture, which causes a shift in the protective spectral band.

Therefore, there is a need for an improved filter to obtain laser protection for a broadband wavelength range and a wide range of incidence angles.

### SUMMARY

An optically transmissive structure for laser protection according to embodiments disclosed herein includes a plurality of metallic layers of material; a plurality of dielectric layers of material; wherein the metallic layers of material are interposed with the dielectric layers of material; the plurality of metallic layers includes layers each having a thickness smaller than a skin depth of the metallic material at a selected wavelength; and the plurality of dielectric layers separating two metallic layers includes layers each having a thickness equal to or smaller than the selected wavelength in the dielectric layer of material. In one embodiment the selected wavelength is in the visible range. In another embodiment, the selected wavelength is between 450 and 650 nanometers. In still another aspect, the selected wavelength is 550 nanometers.

A method for fabricating an optically transmissive structure for laser protection according to embodiments disclosed herein includes the steps of: forming a plurality of metallic layers of material interposed with a plurality of dielectric layers of material on a transparent substrate; wherein the plurality of metallic layers includes layers having a thickness smaller than a skin-depth of the metallic material at a selected wavelength; and the plurality of dielectric layers separating two metallic layers includes layers having a thickness equal to or smaller than the selected wavelength in the dielectric layer of material.

A visual-aid device to be used for protection in hazardous environments including high power electromagnetic radiation according to embodiments disclosed herein includes a support element having a geometry adapted to a user; and an optically transmissive structure. The optically transmissive structure further includes: a plurality of metallic layers of material; a plurality of dielectric layers of material; wherein the metallic layers of material are interposed with the dielectric layers of material. Further, according to embodiments disclosed herein the plurality of metallic layers includes layers having a thickness smaller than a skin-depth of the metallic material at a selected wavelength; and the plurality of dielectric layers separating two metallic layers includes layers having a thickness equal to or smaller than the selected wavelength in the dielectric layer of material.

A multilayered structure for laser protection according to further embodiments disclosed herein includes a first stack of layers comprising metal layers and dielectric layers; a second stack of layers comprising metal layers and dielectric layers; wherein the first stack of layers comprises less than seven layers of material, and provides a visible transmittance of less than thirty percent and the combination of the first stack of layers and the second stack of layers provides a visible transmittance greater than fifty percent and a near infrared optical density greater than two.

A method of forming a multilayered structure for laser protection according to embodiments disclosed herein includes the steps of: providing a first stack of layers comprising metal layers and dielectric layers; providing a second stack of layers comprising metal layers and dielectric layers; wherein the first stack of layers includes less than seven layers of material, and provides a visible transmittance of less than thirty percent and combining the first stack of layers and the second stack of layers to provide a visible transmittance greater than fifty percent and a near infrared optical density greater than two.

An optically transmissive structure for laser protection according to embodiments disclosed herein includes: a plurality of metal layers interposed with dielectric material layers; wherein a transmittance of the structure is greater than fifty percent (50%) for an incident light having a wavelength of 550 nm; and an optical density of the structure is greater than two (2) for an incident light having a wavelength between 1000 nm and 1400 nm. In some embodiments, these parameters are achieved over a range of the angle of incidence from zero to seventy degrees. In still further embodiments, these parameters are achieved for incident energy having both S-polarization and P-polarization.

An optically transmissive structure for laser protection according to embodiments disclosed herein includes: a means for blocking incident radiation at a wavelength greater than 1000 nm and a means for transmitting the majority of incident radiation having a wavelength in the visible range.

These and other embodiments are further described below with reference to the following figures.

### BRIEF DESCRIPTION OF THE DRAWINGS

FIG. 1 shows a partial view of an LP structure according to some embodiments.

FIG. 2 shows a plot of the visible transmittance and the optical density at 1064 nm as a function of total number of layers of an LP structure, according to some embodiments.

FIG. 3 shows a plot of the transmittance and the optical density of an LP structure as a function of the wavelength of the incident light, according to some embodiments.

FIG. 4 shows a plot of the transmittance of an LP structure as a function of the angle of incidence and the wavelength of the incident light, according to some embodiments.

FIG. 5 shows a plot of the optical density at 1064 nm of an LP structure as a function of the angle of incidence for ‘s’ and ‘p’ polarization, according to some embodiments.

FIG. 6 shows a plot of the transmittance and the optical density of an LP structure as a function of wavelength, according to some embodiments.

FIG. 7 shows a plot of the optical density at 1064 nm of an LP structure as a function of the angle of incidence for ‘s’ and ‘p’ polarization, according to some embodiments.

FIG. 8 shows a partial view of an LP structure, according to some embodiments.

FIG. 9 shows a plot of the optical density of LP structures as a function of wavelength, according to some embodiments.

FIG. 10 shows a partial view of an LP structure, according to some embodiments.

FIG. 11 shows a plot of the transmittance and the optical density of an LP structure as a function of wavelength, according to some embodiments.

FIG. 12 shows a partial view of an LP structure according to some embodiments.

FIG. 13 shows a pair of goggles including an LP structure according to some embodiments.

FIG. 14 shows a helmet including a visor having an LP structure according to some embodiments.

In the figures, elements having the same designation have the same or similar functions.

### DETAILED DESCRIPTION

Visible and infrared lasers are used extensively in the military for various applications such as targeting and tracking. In other industries, high power visible and infrared lasers are also used for welding, engraving, marking products and goods, and surgery. In many cases these lasers emit powers that exceed the threshold of eye damage. The eye is vulnerable in the visible range, from approximately 380-400 nm to approximately 700-750 nm, as well as in the near infrared range from approximately 700-750 nm to 1400-1500 nm. In these ranges, the human eye may focus light to a small spot on the retina, potentially causing permanent eye damage. It is therefore important that personnel exposed to these high power laser beams use laser protective devices (visor, goggles etc.) to prevent accidents. With the increasing availability of very compact and high power Commercial Off-The-Shelf (COTS) lasers in the market there is a potential of such lasers being used as weapons. Future lasers may become more frequency agile and filters that protect against a particular wavelength that is out of filter's passband may be vulnerable for lasers that are tuned to a wavelength that is inside filter's passband, thus defeating filtering by the LP structure. Infrared lasers are particularly dangerous since the eye cannot see the light and the eye does not respond (blink reflex) to these wavelengths until permanent damage has already occurred. In a similar manner, man made sensors may be damaged or blinded by high energy lasers. Embodiments consistent with the present disclosure provide LPs that mitigate or highly suppress the potential damage of laser irradiation to the human eye and/or man made sensors.

According to some embodiments disclosed herein, a metal/dielectric photonic band gap structure provides a high OD at wavelengths higher than the visible range, while providing a high transmittance in the visible range. Photonic band gap structures are periodic structures of alternating high and low index of refraction materials. The periodicity creates pass and stop bands, similarly to electronic band gaps in semiconductors. According to some embodiments, materials used in the fabrication of photonic band gap (PBG) structures may be dielectric or semiconductor substances. Dielectrics and semiconductor materials have a low optical absorbance at the wavelength region of interest. For example, in some embodiments the wavelength region of interest for high transmittance is the visible range, from approximately 400 nm to approximately 750 nm.

A metal/dielectric photonic band gap structure and method of fabricating the same is described in detail in U.S. Pat. No. 6,262,830 entitled “Transparent Metallo-Dielectric Band Gap Structure” by Scalora, filed on Sep. 16, 1997, incorporated by reference herein in its entirety. Embodiments consistent with the present disclosure use metal/dielectric photonic band gap structures where the unique combination of layers and layer thicknesses provides a high optical density over a wide range of incidence angles for wavelengths above 800 nm.

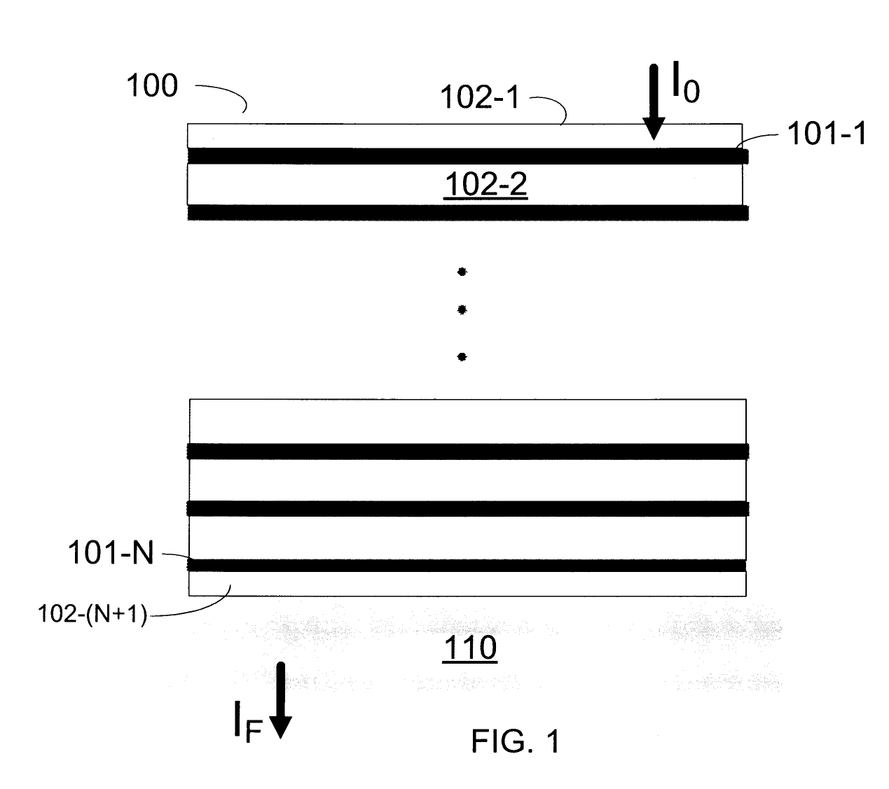

FIG. 1 shows a partial view of an LP structure 100 according to some embodiments. Structure 100 includes a metal stack of layers 101 interposed between, but not necessarily in direct contact with, a dielectric stack of layers 102, on a transparent substrate 110. Substrate 110 can be any optical material suitable for the specific application such as a glass (Pyrex glass) or a polymeric material (Polyethylene Terephthalate (PET) also known as Mylar™, polycarbonate, etc.). The flexibility of LP structure 100 is determined in large part by the type and thickness of the material chosen for substrate 110. In some embodiments, substrate 110 can be PET less than one (1) mil (0.001 inches or about 24 microns) in thickness. In some embodiments, substrate 110 is PET with a thickness between 20 microns and 50 microns. Further embodiments include substrate 110 formed from a polycarbonate sheet having a thickness greater than 20 microns.

According to some embodiments consistent with FIG. 1, the total number of metal layers 101 is an integer value ‘N.’ The precise value of ‘N’ may vary from one embodiment to another, depending on the desired spectral performance for structure 100. In some embodiments as illustrated in FIG. 1, thin metal layers 101 are interposed with dielectric layers 102, such that each metal layer 101 is adjacent to a dielectric layer on both sides of metal layer 101. Thus, in some embodiments structure 100 has N+1 dielectric layers interposed with N thin metal layers. The total number of metal/dielectric layers in LP structure 100 is thus 2N+1, according to embodiments consistent with FIG. 1.

While FIG. 1 shows dielectric layer 102-1 at the top of structure 100 and substrate 110 at the bottom, the definition of ‘top’ and ‘bottom’ is arbitrary, depending on the geometry of the visor or visual element where structure 100 will be deposited. The terms ‘top’ and ‘bottom’ will be used in relation to structure 100 as illustrated in FIG. 1 without loss of generality. In principle, structure 100 is geometrically arranged such that incoming light I₀ impinges from the top on layer 1 first (102-1 and 101-1, in FIG. 1). The incoming light traverses structure 100 in a substantially downward direction, towards substrate 110. Outgoing light I_{f} leaves structure 100 through substrate 110, beyond which an observer captures light I_{f}.

Replacing one of the dielectric materials in a multilayered structure with thin metal layers it is still possible to obtain pass- and stop-bands with optical transmittance approaching 75%. A thin metal layer according to embodiments described herein may have a thickness much smaller than the tunneling wavelength of the structure, λ. Some embodiments may include a plurality of thin metallic layers having a thickness that is about 10 times smaller than λ. In embodiments targeting high transmittance (e.g. ‘tunneling’) for visible light (λbetween 400 and 750 nm), a thin metal layer may be a few tens of nm thick, such as 10, 20, or up to 30 nm.

Embodiments of LP structure 100 consistent with FIG. 1 may use metallic layers 101 having a thickness in the order of, or smaller than the skin-depth of the metallic material at the wavelength λ. Electromagnetic radiation having a wavelength λ also has a frequency, ω, associated with λ. The skin-depth δ of a metal at a frequency ω having conductivity σ and a magnetic permeability μ, may be obtained by the following Equation (‘c’ is the speed of light):

$$δ ≅ \frac{c}{\sqrt{2 πμωσ}} \qquad ( 3 )$$

Eq.(3) (written with constants in CGS units) may be found in the book Classical Electrodynamics, by John D. Jackson, 2^{nd} Edition, p. 298, incorporated herein by reference in its entirety for all purposes.

The resulting multilayered structure may include an aggregated amount of over a hundred nanometers of metal, with limited reduction in optical transmittance. This is significant because a single 50 nm-thick layer of silver (Ag) transmits only about 5% of the incident light in the visible range. In contrast, a plurality of thin silver layers having the same aggregate thickness of 50 nm but spaced from each other by dielectric materials may have a much higher transmittance in the visible range. In some embodiments the visible transmittance of such multilayer of thin silver films may be 75% or higher.

The basic operational principle of the transparent metal stacks is based on resonant tunneling that occurs for those wavelengths λ that are resonant with the metal cavities that are stacked together to form a 1-D photonic band gap structure. Metal layer separation is typically chosen to be approximately λ/4 to λ/2. Light having a wavelength of λ propagates mostly unimpeded with minimal scattering and absorption losses.

Thus, for light having a wavelength much smaller than the ‘tunneling’ wavelength, λ, a “thin” metal layer as described above appears as a thick layer, and high reflectance takes place. For light having wavelengths much larger than λ, the separation between the thin metallic layers is “invisible.” Light having wavelengths much larger than λ sees the multilayered metallic stack as a single, thick metal layer, and thus is reflected as well.

The LP stack is fabricated by traditional thin film deposition techniques. In some embodiments, the metal chosen is silver, which works best for the visible transmission band in combination with a dielectric, such as an oxide material having a high index n˜2. Some embodiments use Ta₂O₅, TiO₂, a combination of Ta₂O₅, and TiO₂, or similar materials as dielectric layers. According to some embodiments, dielectric layers are deposited using reactive sputtering.

In some embodiments consistent with the present disclosure it is desired to have laser protection in the infrared and near infrared regions. In such case, it is desirable to achieve high T in the visible range, and high optical density (OD) in the infrared range. Bulk metals are good reflectors from the visible range to the infrared range and thus are opaque. Alternating metal layers 101 and dielectric layers 102 as shown in FIG. 1 achieves high transmission (T) in the visible range and high OD in the infrared range.

In some embodiments consistent with FIG. 1, LP structure 100 based on metal dielectric multilayer stacks having a high OD in the 700-1400 nm wavelength range, protects from permanent laser damage. In some embodiments an LP structure consistent with the present disclosure includes high Photopic and Scotopic luminous transmittance (>60%). Photopic vision is the vision of the eye under well-lit conditions, allowing accurate color perception. Scotopic vision is the vision of the eye under low light level conditions. The precise spectral power levels defining Photopic and Scotopic conditions for humans are known in the art and will not be described in the present disclosure.

Some embodiments consistent with FIG. 1 include LP structure 100 having a broadband (>700 nm) protection for frequency-agile near IR laser threats. Frequency-agile near IR lasers may be used in military scenarios, and also in industrial, research and surgical environments. Some embodiments of LP structure 100 as in FIG. 1 provide a large angular (omni-directional) protection, as follows. By having thin metal layers 101, incoming light at approximately the tunneling wavelength λ still sees layers 101 as thin, even at steep incident angles. Incoming light at wavelengths much longer than λ still sees structure 100 as a bulk material having a thick metal layer, even at steep incident angles. Incoming light at wavelengths much shorter than λ sees each of metal layers 101 as a thick absorbing metal layer even at steep incident angles. Omni-directional protection is convenient when LP structure 100 is deposited on a visor having a complex geometry.

Embodiments consistent with FIG. 1 provide a single visible passband, substantially rejecting all out of band radiation. Some embodiments of LP structure 100 use a fewer total thin film layers (2N+1) than all-dielectric interference filters, obtaining comparable or even better ODs at selected wavelengths. For example, embodiments consistent with the present disclosure include stacks having between 7-11 total film layers, depending on optical requirements. By comparison, all-dielectric multilayered filter stacks typically include between 25-50 layers of material, or more. This allows cost effective manufacture of LP structure 100, permitting deposition of the layers on rigid as well as flexible substrates.

Embodiments disclosed herein provide an improved laser protection technology that is designed to have high visible transmittance, color neutrality, high optical density in the infrared, angular independence, and cost effective to manufacture. The passband does not shift substantially with increasing angle of incidence and therefore can be applied to more complex shaped visors, canopies, goggles, spectacles, sights, and other visual-aid devices. Embodiments of LP structure 100 consistent with the present disclosure provide laser protection for a wide range of angles of incidence, without degrading visibility. Embodiments of LP structure 100 provide protection for both continuous wave and pulsed laser radiation due to the high reflectivity of the metal layers, even at high incident peak powers. The total number of layers to achieve adequate laser protection, 2N+1, is significantly less than all dielectric interference filters. Thus, LP structure 100 can be deposited on both rigid and flexible substrates at a low cost.

In some embodiments consistent with FIG. 1 LP structure 100 including an optically transmissive substrate 110 has formed thereon at least N=5 layers of metal 101, spaced by at least an equal number of layers of dielectric materials 102. LP structure 100 may further include metal layers 101 having a thickness less than 25 nm. In some embodiments LP structure 100 includes dielectric layers 102 having a thickness less than 100 nm. Some embodiments of LP structure 100 include dielectric layers 102 interposed between metal layers 101, where layers 102 have a substantially constant thickness, according to some embodiments. Further embodiments consistent with FIG. 1 have metal layers 101 varying in thickness from one layer to the next. For example, some embodiments of structure 100 may include layers 101 varying in thickness by approximately 2 nm from layer 101-i to layer 101-(i+1), where ‘i’ is an integer between 1 and N, inclusive.

In some embodiments of LP structure 100, it is desirable for the total thickness of layers 101-1 through 101-N, and 102-1 through 102-(N+1) to be reduced. For example, the total thickness can be less than 1 micron in thickness, or even less than 500 nm in thickness. This may facilitate the application of LP structure 100 on substrates 110 having complex geometries. Furthermore, LP structures 100 consistent with FIG. 1 and having a reduced thickness may substantially reduce the cost of application of such structures in large scale. According to embodiments consistent with FIG. 1, the total thickness of structure 100 may be less than 450 nm, not including the thickness of substrate 110.

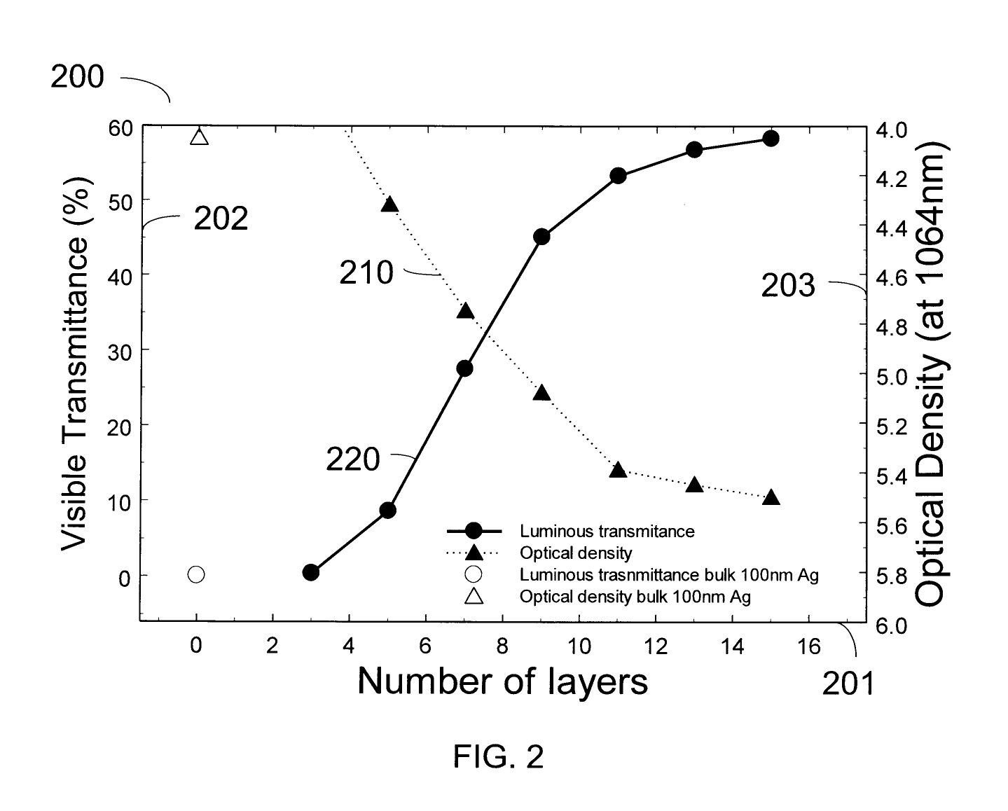

FIG. 2 shows a plot 200 of the visible transmittance 202 and the optical density at 1064 nm 203 as a function of total number of metal layers 201 of an LP structure according to some embodiments. The multilayered structure used for the plot in FIG. 2 is consistent with an LP structure 100 illustrated in FIG. 1, with the total number of layers 201 being 2N₊1. According to embodiments consistent with FIG. 2 visible transmittance 202 is the transmittance T as in Eq. (2) where I₀ and I_{f} include light in the wavelength range between 400 nm and 750 nm.

The effect of number of layers 201 on the optical performance of LP structure 100 is illustrated in FIG. 2. Visible transmittance 202 (wavelengths 400-750 nm) and OD at 1064 nm 203 are plotted as a function of number of layers 201. For each value of number of layers 201, the aggregated amount of silver thickness across layers 101-1 through 101-N is kept constant at 100 nm. The dielectric spacer 102 is chosen as Ta₂O₅, each with a physical thickness of 70 nm, for each value of number of layers 201. For comparison, the visible transmittance (open circle) and the OD at 1064 nm (open triangle) for a bulk layer of silver having a thickness of 100 nm is also shown. For the case of a bulk, 100 nm thick layer of silver a high OD at 1064 nm (˜4) is achieved (open triangle). However, visible transmittance (open circle) is less than 0.1%, making the bulk, 100 nm thick layer of silver essentially opaque to visible light. By contrast, as number of layers 201 in LP structure 100 is increased, transmittance 202 is increased, as shown by curve 220. Also, OD at 1064 nm 203 increases, as illustrated by curve 210. Note that in FIG. 2 the scale for OD at 1064 nm 203 increases downward.

For example, for a fifteen (15) layer stack with seven (7) silver layers (N=7), each having a thickness of 14.28 nm, visible transmittance 202 of nearly 60% and OD at 1064 nm 203 of 5.5 can be achieved. In general, a compromise exists between visible transmittance 203 and OD at a given wavelength in the infrared (e.g. OD at 1064 nm 203). Using higher number of layers 201 such that each metal layer is thinner (for a pre-determined aggregated thickness of metal) makes the transmission band wider and more color neutral, providing a sharper cutoff in the IR. In some embodiments of LP 100 consistent with the present disclosure using fewer and thicker metal layers achieves high OD in the IR. But thicker metal layers also result in a significant reduction of the visible passband leading to low visible transmittance, high reflectance, and color distortion. LP structures 100 having reduced number of layers 201 may be used in embodiments for applications that tolerate higher reflectivities. This is because the reflectivity of an LP structure having low number of layers may not be efficiently suppressed with anti-reflection coatings. Embodiments having more restrictive limitations for reflectivity use LP structure 100 having N equal to at least four (4), resulting in a total of nine (9) metal/dielectric layers 201.

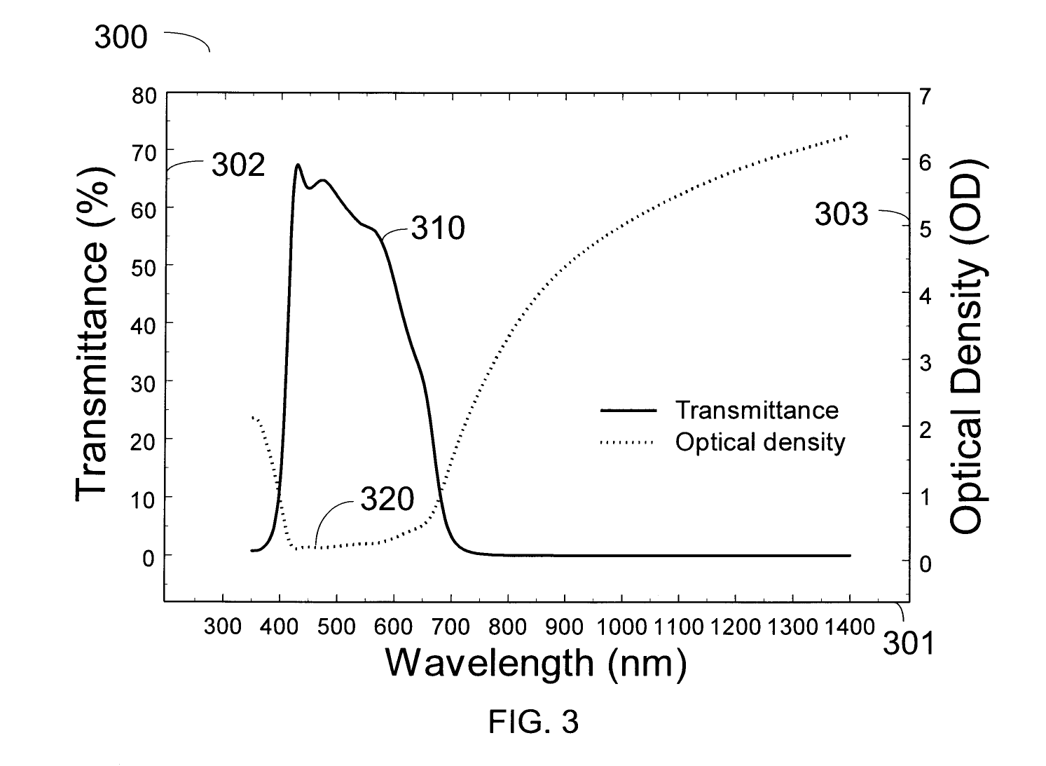

FIG. 3 shows a plot 300 of the transmittance 302 and the OD 303 of LP structure 100 as a function of the wavelength of the incident light 300 according to some embodiments. Embodiments of LP structure 100 used to obtain plot 300 may include eleven (11) metal/dielectric layers with N=5 silver layers 101 and six (6) dielectric layers 102. Each silver layer 101 having a thickness of 20 nm. Each dielectric layer 102 may be formed of Ta₂O₅ and have a thickness of 70 nm. The resulting LP structure 100 includes a polycarbonate substrate 110 (cf. FIG. 1). Transmittance 302 is shown in curve 310, while OD 303 is shown in curve 320. Curve 310 shows that LP structure 100 consistent with FIG. 3 has transmittance 302 greater than 54% in a visible range from about 420 nm to about 570 nm. Curve 320 shows that LP structure 100 consistent with FIG. 3 has OD 303 greater than three (3) from 800-1400 nm. FIG. 3 illustrates that out of band incident light having a wavelength less than about 400 nm and higher than about 700 nm is substantially rejected.

According to some embodiments consistent with FIGS. 1-3, LP structure 100 includes a stack of eleven (11) metal/dielectric layers (N=5) on a Pyrex glass substrate 110, as follows. Metal layers 101-1 through 101-5 are made of silver, and dielectric layers 102-1 through 102-6 are made of Ta₂O₅. Layers 101 and 102 have thicknesses as shown in Table I, below:

TABLE I

| Layer No. | Thickness (nm) |
|---|---|
| 101-1 | 20 |
| 101-2 | 20 |
| 101-3 | 20 |
| 101-4 | 20 |
| 101-5 | 20 |
| 102-1 | 37 |
| 102-2 | 74 |
| 102-3 | 74 |
| 102-4 | 74 |
| 102-5 | 74 |
| 102-6 | 37 |

Embodiments of LP structure 100 consistent with Table I provide transmittance 302 greater than 55% in a visible wavelength range including wavelengths from about 420 nm to about 580 nm. Also, embodiments of LP structure 100 consistent with Table I provide OD 303 greater than about 3.5 in the infrared region beyond 800 nm.

Further embodiments consistent with FIGS. 1-3, include LP structure 100 having a stack of nine (9) metal/dielectric layers (N=4) on a thin polycarbonate substrate 110, as follows. Metal layers 101-1 through 101-4 are made of silver, and dielectric layers 102-1 through 102-5 are made of Ta₂O₅. Layers 101 and 102 have thicknesses as shown in Table II, below:

TABLE II

| Layer No. | Thickness (nm) |
|---|---|
| 101-1 | 22.64 |
| 101-2 | 22.33 |
| 101-3 | 24.96 |
| 101-4 | 22.35 |
| 102-1 | 32.64 |
| 102-2 | 65.49 |
| 102-3 | 67.94 |
| 102-4 | 71.24 |
| 102-5 | 38.46 |

Embodiments of LP structure 100 consistent with Table II provide visible transmittance 202 of approximately 50% (cf. FIG. 2). Also, embodiments of LP structure 100 consistent with Table II provide OD 303 greater than about three (3) at 800 nm, OD 303 greater than about four (4) at 900 nm, and OD 303 greater than about 4.5 in the infrared region beyond 1064 nm.

Further embodiments consistent with FIGS. 1-3, include LP structure 100 having a stack of nine (9) metal/dielectric layers (N=4) on a thin polycarbonate substrate 110, as follows. Metal layers 101-1 through 101-4 are made of silver, and dielectric layers 102-1 through 102-5 are made of Ta₂O₅. Layers 101 and 102 have thicknesses as shown in Table III, below:

TABLE III

| Layer No. | Thickness (nm) |
|---|---|
| 101-1 | 20.34 |
| 101-2 | 19.70 |
| 101-3 | 20.02 |
| 101-4 | 16.22 |
| 102-1 | 38.13 |
| 102-2 | 69.44 |
| 102-3 | 77.65 |
| 102-4 | 75.76 |
| 102-5 | 39.80 |

Embodiments of LP structure 100 consistent with Table III provide visible transmittance 202 of approximately 65% (cf. FIG. 2). Also, embodiments of LP structure 100 consistent with Table III provide OD 303 greater than about two (2) at 800 nm, OD 303 greater than about three (3) at 900 nm, and OD 303 greater than about four (4) in the infrared region beyond 1064 nm.

The examples of LP structure 100 as described in Tables I-III are illustrative only, and not limiting. Some embodiments of LP structure 100 consistent with FIG. 1 may include metal layers 101 and dielectric layers 102 having similar thicknesses as detailed in Tables I-III. In some embodiments, the thicknesses of metal layers 101 may be different from those illustrated in Tables I-III by up to one (1), two (2), or a few nm. In some embodiments, the thicknesses of dielectric layers 102 may be different from those illustrated in Tables I-III by one (1), two (2), or a few nm. Some embodiments may have a similar arrangement of layers as described in Tables I-III in terms of number and thickness, including metals other than silver for layers 101. Some embodiments may include gold (Au), aluminum (Al), or copper (Cu) layers, or a combination of layers made of different metals. Some embodiments may have a similar arrangement of layers as described in Tables I-III in terms of number and thickness, including dielectric materials other than Ta₂O₅ for layers 102, such as magnesium fluoride, calcium fluoride, and various metal oxides.

The choice of materials and thicknesses in the metal/dielectric layers according to embodiments disclosed herein depends on the specific application sought for LP structure 100. Some embodiments use silver as the metal of choice for layers 101, and the specific thicknesses of layers 101 and 102 is designed to have transmittance 302 centered at a wavelength, λ, close to 550 nm, or 560 nm. Some applications may benefit from having transmittance 302 centered at wavelengths, λ, closer to a near-infrared region, such as 700 nm. In these cases, embodiments of LP structure 100 include gold metal layers 101. Still further, for night vision use the passband may be extended up to about 950 nm. In this configuration, the pass window of transmittance would be about 400-950 nm with a center wavelength of approximately 675 nm.

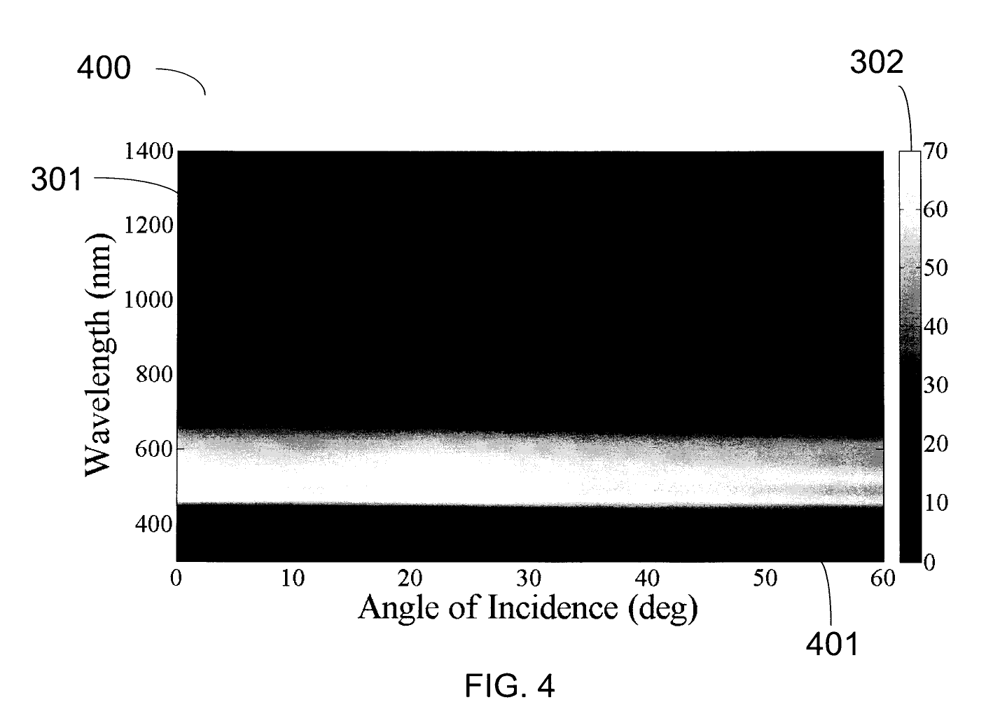

In order to see the angular dependence of LP structure 100 consistent with FIG. 3, the transmittance is plotted as function of incident angle, as described in detail below in relation to FIG. 4.

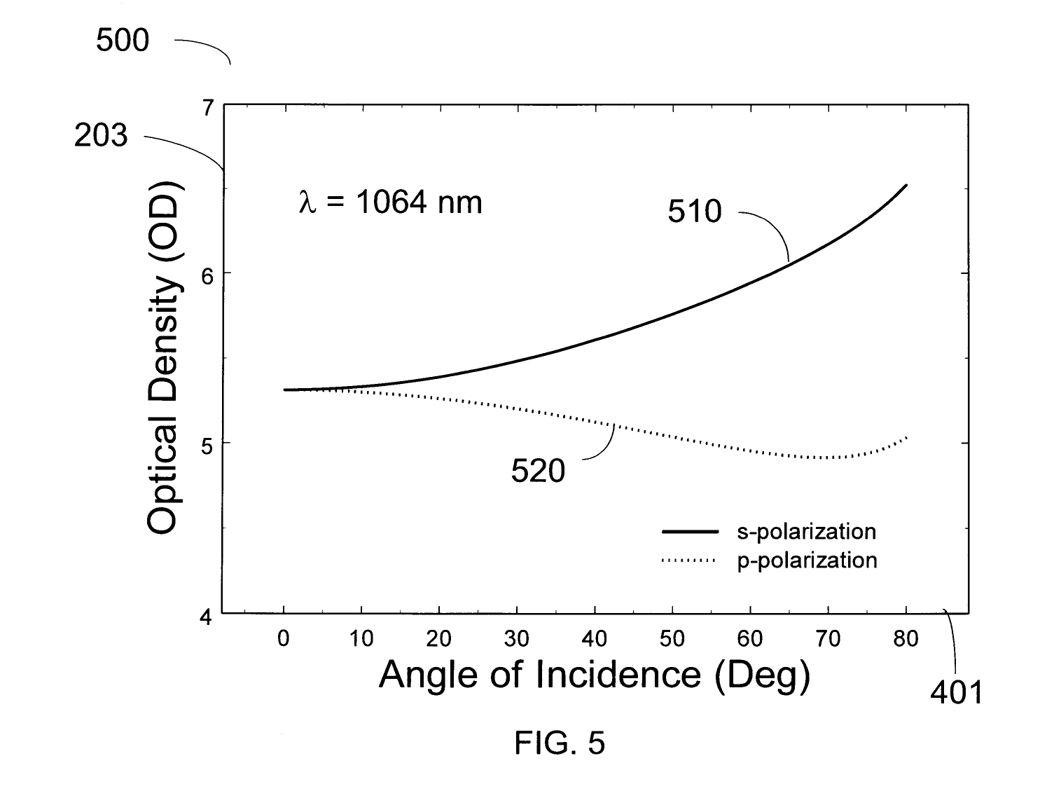

FIG. 4 shows a plot 400 of transmittance 302 of an LP structure as a function of the angle of incidence 401 and a function of wavelength 301 according to some embodiments. Angle of incidence 401 according to FIG. 4 is measured relative to the substrate normal (up-down direction in FIG. 1). While FIG. 4 illustrates a general concept, the LP structure 100 used to obtain plot 400 is consistent with that used for FIG. 3. That is, the LP structure 100 in FIG. 4 has a total of five (5) layers 101 of silver, each having a 20 nm thickness, interposed with six (6) layers 102 of Ta₂O₅. FIG. 4 shows the resilience of the optical performance of LP structures 100 consistent with the present disclosure for a wide range of angles of incidence. According to embodiments consistent with FIG. 4, the passband of LP structure 100 shifts by less than 10 nm as the angle of incidence of light I₀ varies from 0 to 40 degrees. The passband of LP structure 100 is the spectral region where transmittance 302 is at least one half (½) the maximum transmittance of LP structure 100 (cf. FIG. 3). According to embodiments consistent with FIG. 4, transmittance 302 and optical density 303 of LP structure 100 may change by less than ten percent (10%) for an incident light having a wavelength and an angle of incidence between zero (0) and sixty (60) degrees. The wavelength for which the optical properties of LP structure 100 is maintained through a wide range of angles of incidence may be between less than 400 nm (or about 350 nm), and 1400 nm (cf. FIG. 4). FIG. 5 illustrates OD at 1064 nm 203 of LP structure 100 consistent with FIGS. 1-4, as a function of angle of incidence for s- and p-polarized incident light, as described in detail below.

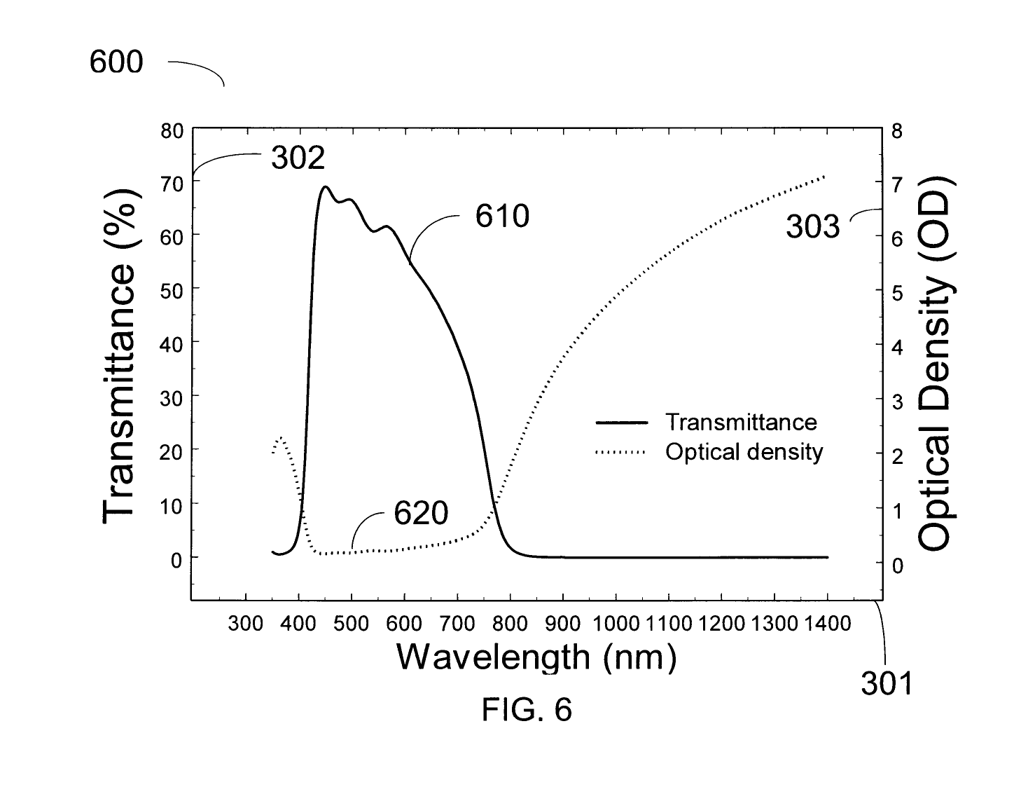

FIG. 5 shows a plot 500 of OD at 1064 nm 203 of an LP structure 100 as a function of angle of incidence 401 for ‘s’ and ‘p’ polarization, according to some embodiments. S-polarization refers to incident light having a polarization vector perpendicular to the plane of incidence formed by the incoming direction and the normal to LP structure 100. P-polarization refers to incident light having a polarization vector in the plane of incidence. While FIG. 5 illustrates a general concept, the LP structure 100 used to obtain plot 500 includes an eleven (11) layer stack as described above in relation to FIGS. 3 and 4. Plot 500 includes curve 510 for s-polarized incident light and curve 520 for p-polarized incident light. As FIG. 5 shows, OD at 1064 nm 203 is higher than 4.5 at all angles of incidence for curve 510 and curve 520. The P-polarization in general represents a lower OD for laser protection, not limited to OD at 1064 nm 203. In some embodiments, the minimum value of OD occurs for p-polarized radiation incident at the Brewster angle in a metal/dielectric interface. For example, the Brewster angle occurs at approximately 70° for embodiments consistent with FIG. 5. Transmittance 302 and OD 303 of LP 100 can be optimized by selecting the thicknesses of metal layers 101 and dielectric layers 102. Thus, embodiments consistent with FIG. 5 have OD 303 in the near infrared greater than OD 303 for p-polarized light at the Brewster angle, for all angles of incidence, and all polarization states. FIG. 6 shows the optical performance of a fifteen (15) layer structure alternating eight (8) dielectric layers 102 of Ta₂O₅ and seven (7) conductive layers 101 of silver, as described in detail as follows. The metal layer thicknesses in FIG. 6 are 12 nm (layer 101-1), 14 nm (layer 101-2), 16 nm (layer 101-3), 18 nm (layer 101-4), 16 nm (layer 101-5), 14 nm (layer 101-6), 12 nm (layer 101-7).

In some embodiments, LP structure 100 may be made to have a directional preference such that a desired visible transmittance 202 and infrared optical density 203 is obtained for a pre-selected angle of incidence 401. To build a structure the design would be optimized for a selected angle of incidence with the desired transmittance and optical density as design optimization parameters. The structure could then be built based on the optimized design.

FIG. 6 shows a plot 600 of transmittance 302 and OD 303 of LP structure 100 as a function of wavelength 301, according to some embodiments. While FIG. 6 illustrates a general concept, the LP structure 100 used to obtain plot 600 includes a fifteen (15) layer stack having N=7 (cf. FIG. 1 above). Embodiments of LP structure 100 consistent with FIG. 6 may include a first dielectric layer 102-1 and last dielectric layer 102-(N+1) (N=7, cf. FIG. 1) having a thickness equal to ½ the thickness of intermediate dielectric layers 102-2 through 102-N (cf. Table I, above). Some embodiments consistent with FIG. 6 may have LP structure 100 including silver layers 101 increasing by approximately 2 nm from the top layer (101-1, cf. FIG. 1) to a maximum thickness at a middle layer. Then, silver layers 101 in LP structures 100 consistent with FIG. 6 may decrease in thickness by approximately 2 nm until the bottom layer 101-N. Tailoring of the thicknesses of metal layers 101 near the top and bottom of LP structure 100 improves transmittance in the passband, as shown in FIG. 6 (cf. Tables II and III, above).

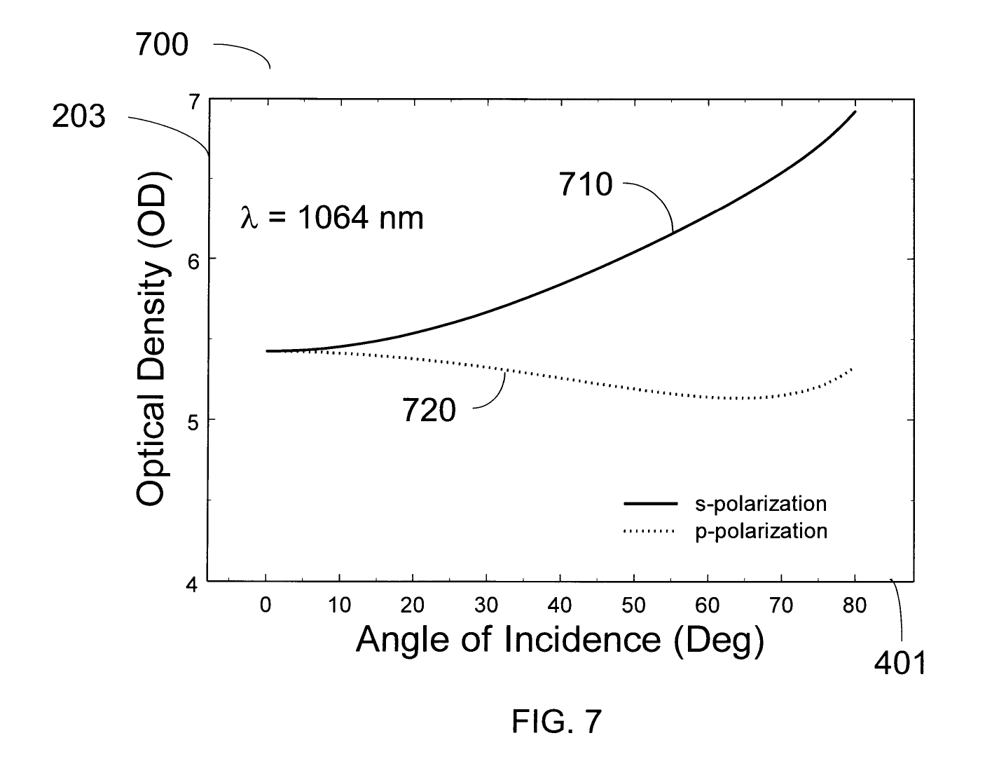

In FIG. 6, plot 600 includes curve 610 for transmittance 302 and curve 620 for OD 303. Curve 620 shows OD 303 at 900 nm greater than four (4) (approximately equal to 4.15) and OD 303 at 1064 nm greater than (5) (approximately equal to 5.66). Curve 620 also shows an OD 303 at 800 nm greater than 2 (approximately equal to 2.33). To demonstrate the resilience of the optical performance of LP structure 100 used for FIG. 6 with angular incidence, FIG. 7 plots OD at 1064 nm 203 as a function of angle of incidence for s- and p-polarized incident light, as described in detail below.

FIG. 7 shows a plot 700 of optical density at 1064 nm 203 of an LP structure as a function of angle of incidence 401 for ‘s’ and ‘p’ polarization according to some embodiments. While FIG. 7 illustrates a general concept, the LP structure 100 used to obtain plot 700 includes a fifteen (15) layer stack having N=7 (cf. FIG. 1 above) consistent with FIG. 6. Thus, embodiments of LP structure 100 consistent with FIG. 7 may include a first dielectric layer 102-1 and a last dielectric layer 102-(N+1) (N=7, cf. FIG. 1) having thickness equal to ½ the thickness of intermediate dielectric layers 102-2 through 102-N. Furthermore, embodiments consistent with FIG. 7 may include tailoring of the thickness of metal layers near the top and bottom of LP structure 100, as described above in relation to FIG. 6.

Plot 700 in FIG. 7 includes curve 710 of OD at 1064 nm 203 for s-polarized light, and curve 720 of OD at 1064 nm 203 for p-polarized light as a function of angle of incidence. As FIG. 7 shows, OD at 1064 nm remains higher than five (5) at all incident angles. The p-polarization in general represents lower values of OD for laser protection, not limited to OD at 1064 nm 203 (cf. FIG. 5).

FIG. 7 shows that LP structure 100 in embodiments consistent with the present disclosure may be designed to have an OD approximately equal to four (4) at 800 nm and greater than four (4) for longer wavelengths. LP structures 100 having fifteen (15) layers consistent with FIG. 7 have a reduced overall visible transmittance (cf. curve 610 in FIG. 6), but a high OD at 1064 nm 203 greater than five (5) is achieved (cf. curve 620 in FIG. 6 and curves 710-720 in FIG. 7). Embodiments consistent with FIG. 7 achieve a high OD over a wide range of incidence angles for wavelengths above 800 nm.

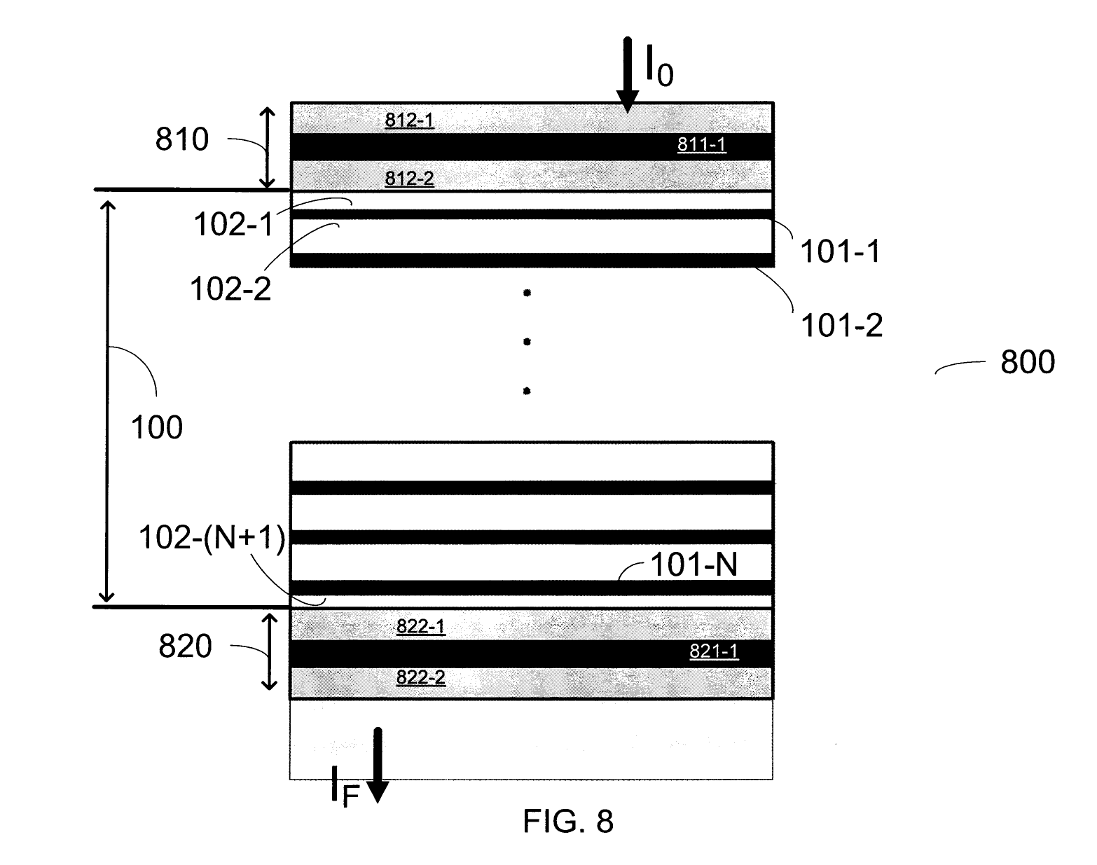

Some embodiments of LP structure 100 consistent with the disclosure herein include a dielectric/dielectric stack in combination with metal/dielectric stacks. This will be described in detail below, in reference to FIG. 8.

FIG. 8 shows a partial view of an LP structure 800 according to some embodiments. LP structure 800 is a hybrid design including dielectric/dielectric stacks 810 and 820 (short wave passband filter) together with a metal/dielectric coating as in LP structure 100 (cf. FIG. 1).

Embodiments of LP structure 800 consistent with FIG. 8 have the beneficial transmittance 302 and OD 303 properties of LP structure 100 (cf. FIGS. 1-7), enhanced by the addition of dielectric/dielectric stacks 810 and 820. Dielectric stack 810 may be placed on top of LP structure 800, and stack 820 may be placed at the bottom of the metal/dielectric layer stack, on top of substrate 110, according to some embodiments of LP structure 800. In general, dielectric/dielectric stacks 810 and 820 include alternating layers of dielectric materials having high and low index of refraction relative to each other. Some embodiments may include stacks 810 and 820 having the same structure. Some embodiments consistent with LP structure 800 may include stacks 810 and 820 having different structures. For example, stack 810 may include layers 812-1 and 812-2 with a dielectric material (L) having low index of refraction relative to layer 811-1 with a dielectric material (H) having high index of refraction. Likewise, stack 820 may include layers 822-1 and 822-2 with a dielectric material (L) having low index of refraction relative to layer 821-1 with a dielectric material (H) having high index of refraction.

In principle, embodiments of LP structure 800 consistent with FIG. 8 may have different dielectric materials for each of the layers 812-1, 812-2, 811-1, 822-1, 822-2, and 821-1. The general concept in LP structures 800 consistent with FIG. 8 is the alternate stacking of L/H type of dielectric materials. Furthermore, the exact number and thickness of the layers of dielectric materials in stack 810 may be different to the number and thickness of the layers of dielectric material in stack 820.

According to embodiments consistent with FIG. 8, LP structure 800 includes metal layers 101-1 through 101-N, interposed with dielectric layers 102-1 through 102-(N+1), such as described in detail above regarding LP structure 100.

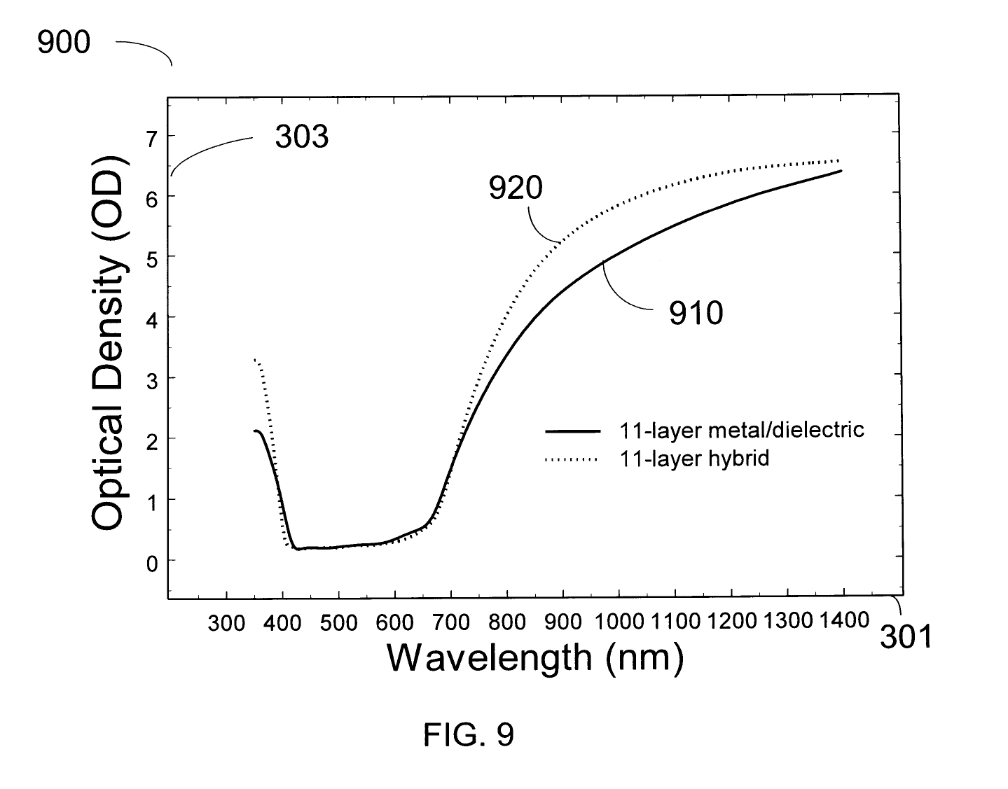

According to some embodiments of LP 800 consistent with FIG. 8, stacks 810 and 820 have the same structure. In some embodiments, the structure of stacks 810 and 820 may include the following layers: SiO₂ (78 nm)/TiO₂(96 nm)/SiO₂(78 nm) denoted as low/high/low index (LHL). Stacks 810 and 820 enhance the short wave passband of LP structure 800. Stacks 810 and 820 act as a short pass filter with a cutoff around 800 nm. The two stacks 810 and 820 act together with the metal/dielectric stack to provide the optical performance. In the illustrated and described embodiments there is an overall interference effect between the unit cells 810, 100 and 820. The optical performance of LP structure 800 consistent with FIG. 8 is shown in FIG. 9, described in detail below.

FIG. 9 shows a plot 900 of OD 303 for LP structures 100 and 800 as a function of wavelength 301, according to some embodiments. Plot 900 includes curve 910 of OD 303 for an LP structure 100 consistent with FIG. 1 and including eleven (11) metal/dielectric layers, as described in detail with reference to FIG. 3 above (N=5, cf. FIG. 1). Plot 900 includes curve 920 of OD 303 for an LP structure 800 consistent with FIG. 8 including LP structure 800 having dielectric/dielectric stacks 810 and 820. Without loss of generality the dielectric stacks 810 and 820 used to obtain curve 920 are identical, and include low/high/low index layers: SiO₂ (78 nm)/TiO₂(96 nm)/SiO₂(78 nm).

FIG. 9 shows that the addition of dielectric/dielectric layers to LP structure 800 leaves OD 303 virtually unchanged in the visible range (OD having very low values in this range, as desired for good visibility). In addition the optical performance of LP structure 800 is enhanced in the near infrared range, as can be seen by higher OD 303 values of curve 920 relative to curve 910 from about 800 nm to about 1400 nm.

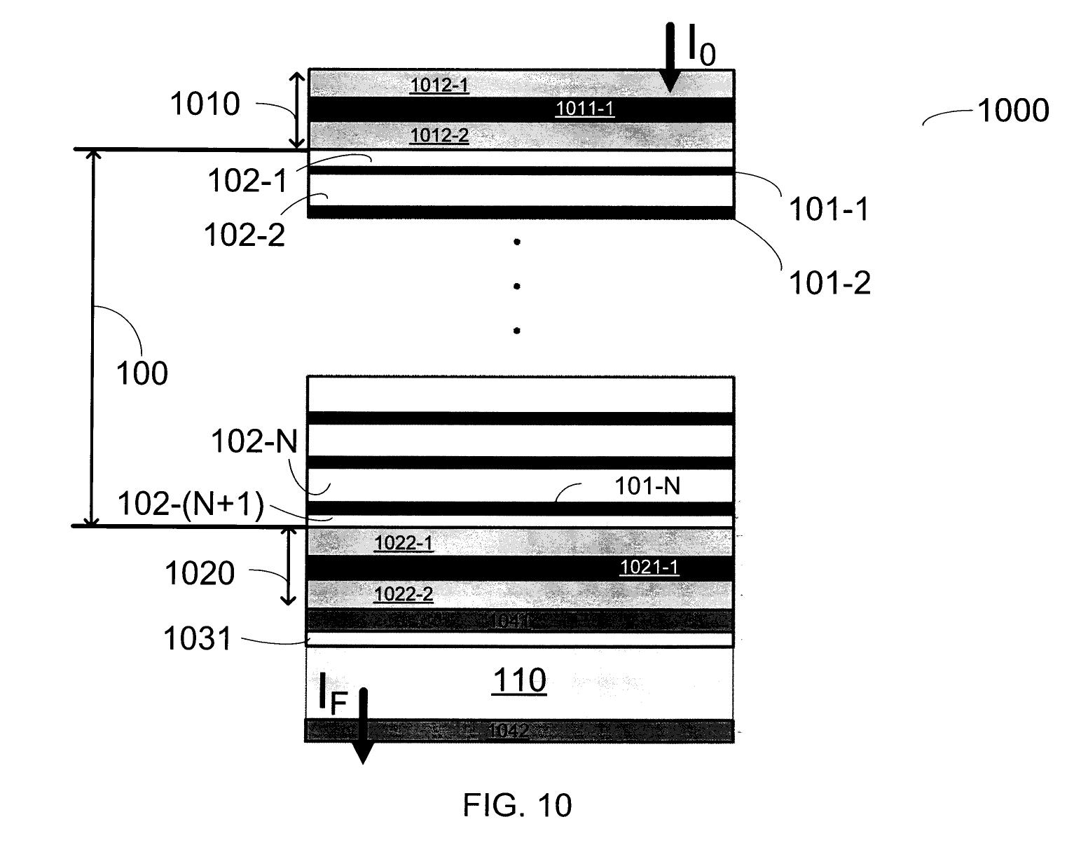

FIG. 10 shows a partial view of an LP structure 1000 according to some embodiments. LP structure 1000 includes a number of additional layers such as adhesion layer 1031, anti-reflection (AR) layers 1041 and 1042, and metal protective layers (not shown in FIG. 10). Adding dielectric/dielectric stacks 1010 and 1020 improves OD 303 in the infrared region, particularly between wavelengths in the range of 800-1400 nm. For example, some embodiments of LP structure 1000 may have stacks 1010 and 1020 as stacks 810 and 820 in LP structure 800 (cf. FIG. 8). Also shown in FIG. 10 is a stack of metal/dielectric layers including layers 101-1 through 101-N interposed with dielectric layers 102-1 through 102-(N+1), as described in detail above in relation to LP structure 100 (cf. FIG. 1). Also included in LP 1000 is substrate 110 as described in relation to LP structure 100 (cf. FIG. 1), according to some embodiments.

When depositing metal layers 101 and dielectric layers 102 some embodiments of LP structure 1000 include layer 1031 to provide better adhesion between the multilayer stack and substrate 110. Adhesion between the metal/dielectric stack and a polycarbonate substrate 110 may be improved by using layer 1031 made of a thin metal layer, or a SiO₂ layer. In some embodiments, a thin adhesion layer similar to 1031 is included between metal layers 101 and dielectric layers 102 to improve stability of LP structure 1000 (not shown in FIG. 10, for simplicity). In some embodiments it may be desirable to protect the metal layer from oxidation, in which case a barrier layer may be deposited such as Si₃N₄ on either side of each of metal layers 101-1 through 101-N. According to embodiments of LP structure 1000 consistent with FIG. 10, multilayer stacks 1010 and 1020 provide a reflectance of less than 1% in the visible range.

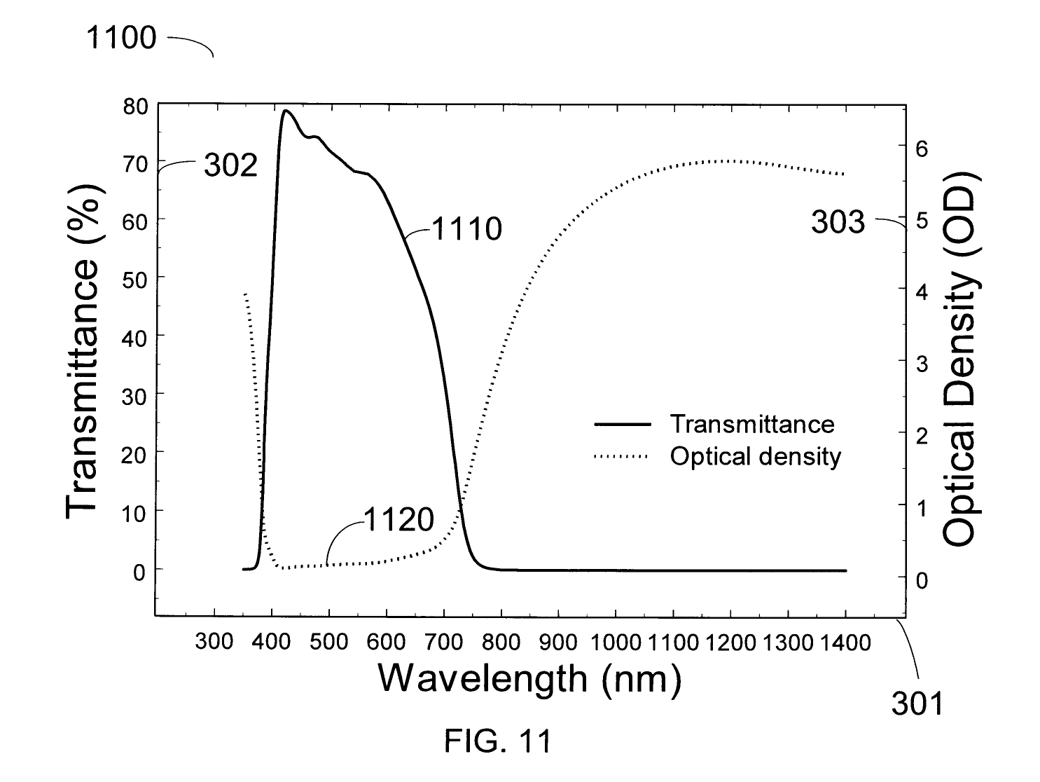

When the stack of metal/dielectric layers 101/102 is deposited on a thick substrate 110 such as glass or polycarbonate, there will be light reflection from both surfaces of substrate 110. Some embodiments of LP structure 1000 reduce this reflection by incorporating anti-reflection layers 1041 and 1042, increasing the visible transmission. The optical performance of LP structure 1000 consistent with FIG. 10 is shown in FIG. 11, described in detail below.

FIG. 11 shows a plot 1100 of transmittance 302 and optical density 303 of an LP structure as a function of wavelength 301 according to some embodiments. The LP structure used to obtain plot 1100 is consistent with LP structure 1000 described in detail in reference to FIG. 10 above. While FIG. 11 shows a general behavior, without loss of generality the particular LP structure 1000 chosen to obtain plot 1100 includes a stack of eleven (11) metal/dielectric layers 101 and 102 (N=5, cf. FIG. 10). LP 1000 consistent with FIG. 11 further includes layers 1010, 1020, 1031, 1041, and 1042 as shown in FIG. 10. In the embodiment of LP structure 1000 used to obtain plot 1100 adhesion layer 1031 is made of SiO₂, and further Si₃N₄ protective layers are provided adjacent to metal layers 101-1 through 101-5, on either side of each. Plot 1100 includes curve 1110 showing transmittance 302, and curve 1120 showing OD 303, as a function of wavelength 301. Curve 1110 shows that LP structure 1000 as described above provides about 65% of visible light transmission in the wavelength range from about 400 nm to about 590 nm. Curve 1120 shows that LP structure 1000 as described above provides less than 1% visible reflectance (OD˜0.01) and OD 303 greater than 3 in the infrared region from about 800 nm to 1400 nm.

Embodiments consistent with the disclosure herein include a number of layers 201 that may be as low as three (3), or seven (7), nine (9), eleven (11), or fifteen (15) total layers. The number of layers 201 of a given embodiments is not limiting, and depends on the specific application sought for LP structure 100. In some embodiments, a higher number of metal layers 101 increases OD 303 in the near infrared for LP structure 100. In some embodiments, a reduced number of metal layers 101 increases visible transmittance 202 for LP structure 100.

Embodiments consistent with the present disclosure provide transmittance 302 at the selected wavelength of λ=550 nm greater than 50%, greater than 60%, and greater than 65%, depending on the number of layers 201 and the thickness of each layer. Also, embodiments disclosed herein provide OD 303 at 900 nm greater than three (3), four (4), and 4.5, depending on the number of layers and the thickness of each layer.

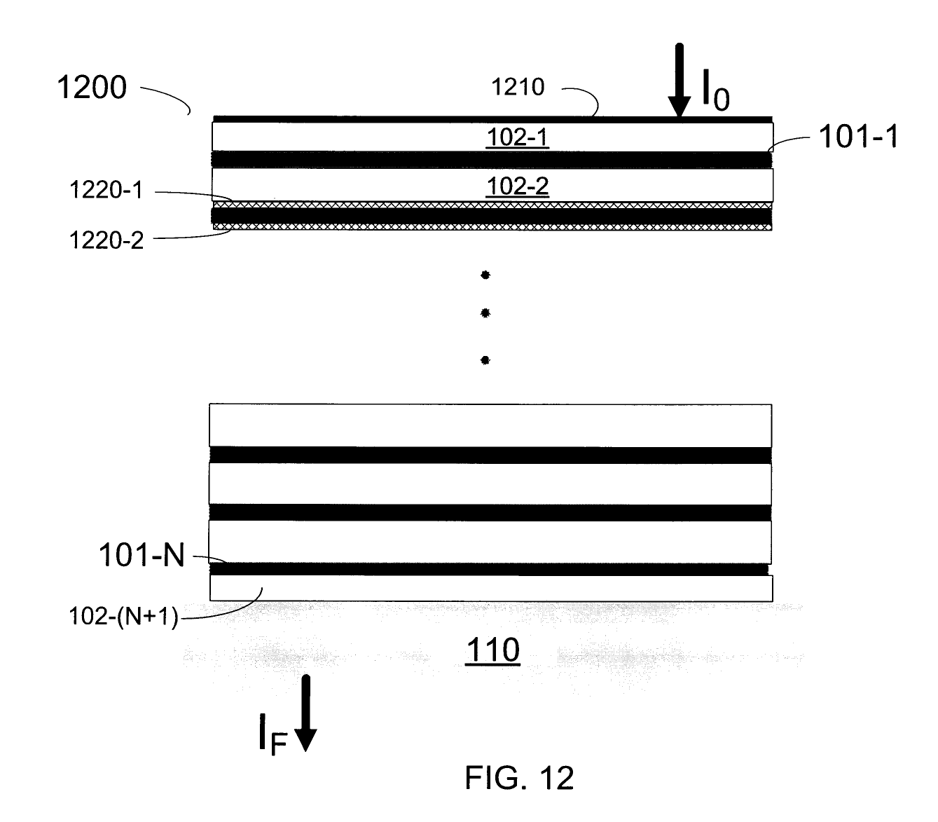

FIG. 12 shows a partial view of an LP structure 1200 according to some embodiments. LP structure 1200 consistent with FIG. 12 may provide visible wavelength filtering at pre-selected wavelengths by incorporating layer 1210 including a visible dye. Such a device would then provide protection for a specific visible laser and infrared laser threats. For example, some embodiments consistent with FIG. 12 may have dye layer 1210 injected on top of layer 102-1, targeting absorption of a pre-selected visible laser threat. In addition, embodiments consistent with FIG. 12 may include metal protective layers 1220-1 and 1220-2. Layers 1220-1 and 1220-2 include a 3-4 nm layer of silicon nitride Si₃N₄ as a barrier between each of the metal 101 (e.g. silver) and dielectric 102 layers. Adding silicon nitride layers 1220-1 and 1220-2 increases the thickness of the stack slightly, while strongly inhibiting oxidation of metal layers 101, enhancing visible light transmission. Metal oxides such as silver oxide are generally opaque in the visible range. According to embodiments consistent with FIG. 12, two silicon nitride layers 1220-1 and 1220-2 may be placed adjacent to each metal layer 101-1 through 101-N in LP structure 1200.

In some embodiments consistent with FIG. 12, LP structure 1200 may include silicon nitride layers adjacent to some, but not all, of metal layers 101. For example, some embodiments may include silicon nitride layers 1220 adjacent to metal layers 102-1 and 101-N, closer to the outer edges of structure LP 1200.

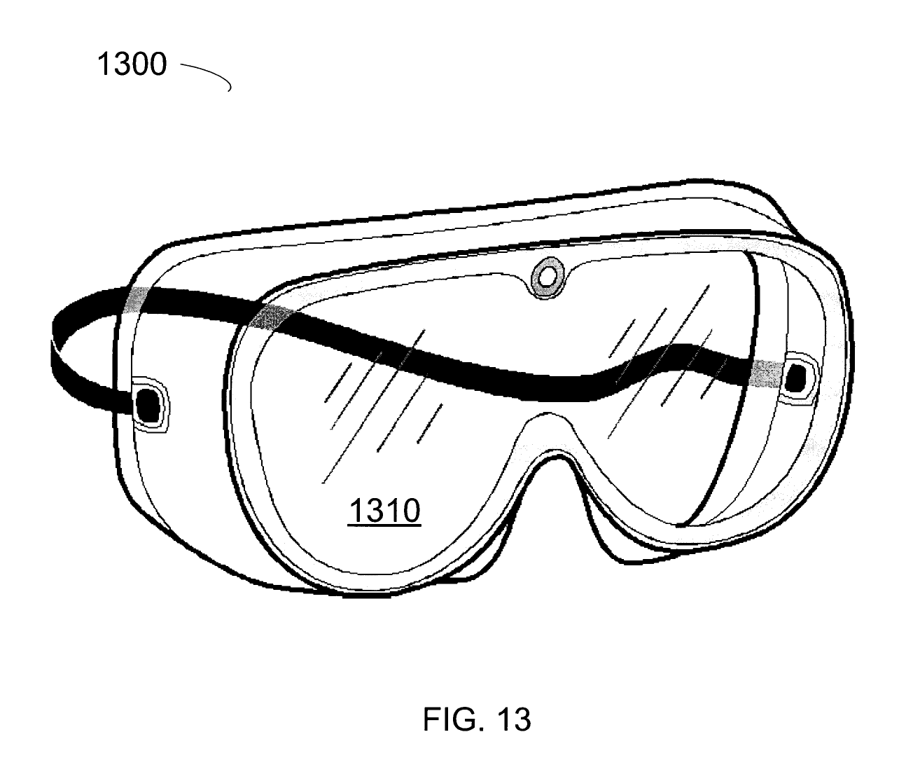

FIG. 13 shows a pair of goggles 1300 including LP structure 1310 according to some embodiments. LP structure 1310 may include layers and materials consistent with FIGS. 1, 8, 10 and 12, or described in Tables I, II, and III above. Goggles such as 1300 may be used in military scenarios, or also by police, in civilian applications. Embodiments of goggles 1300 may also be used by airline pilots, or by surgeons and nurses in surgical rooms. Further, while goggles are illustrated, glasses, contacts or other eye lenses may incorporate the LP embodiments disclosed above.

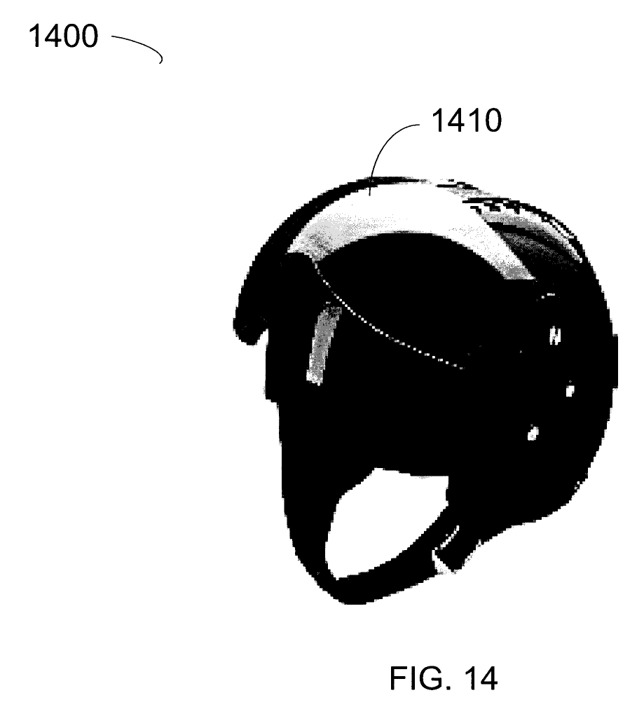

FIG. 14 shows helmet 1400 including a visor 1410 having an LP structure according to some embodiments. Visor 1410 may include an LP structure having layers and materials consistent with FIGS. 1, 8, 10, and 12, or described in Tables I, II, and III above. Helmet 1400 may also be used in military scenarios, or by police and or civilian pilots in aircraft.

Embodiments consistent with FIGS. 1-14 include thin-film metal/dielectric multilayer stacks providing enhanced LP for laser threats in infrared wavelengths. LP structures such as structure 100, 800 and 1000 above (cf. FIGS. 1, 8, and 10, respectively) also provide enhanced visible transmittance 202 (cf. FIG. 2). In some embodiments, LP structures consistent with the disclosure herein provide greater than 60% transmittance between 400 and 750 nm. Also, in some embodiments consistent with the disclosure herein LP structures include a metal-dielectric thin-film stack having relatively few layers (low value of N, cf. FIG. 1) and a total thickness less than 1 micron. Some embodiments consistent with the present disclosure include a low value of N such as 5 or 7, for a total number of layers of 11 and 15, respectively. LP structures consistent with the present disclosure provide an OD at 1064 nm 203 equal to or greater than four (4) (cf. curve 1120 in FIG. 11). LP structures consistent with the present disclosure provide OD at 1064 nm 203 equal to or greater than four (4) for any polarization of the incident light (cf. FIGS. 5 and 7). Embodiments of LP structures consistent with the present disclosure include anti-reflection stacks for the visible passband (400-750 nm) and are highly reflective for light outside of the passband region.

Some embodiments of LP structures according to the present disclosure provide a passband that does not shift more than 10 nm as the angle of incidence of the incoming light is varied from 0° to 40° (cf. FIG. 4). Some embodiments of LP structures consistent with the present disclosure provide a single optical passband with greater than 60% transmittance between 400 and 750 nm rejecting all other wavelengths, including microwave radiation.

Embodiments of LP structures consistent with the disclosure herein can be reliably deposited on rigid and flexible substrates by including adhesive dielectric layers such as layer 1031 (cf. FIG. 10). Furthermore, some embodiments may enhance the stability of the LP structure by adding adhesive layers such as layer 1031 between each of the metal/dielectric interfaces.

The metal-dielectric thin-film stack in LP structures consistent with the present disclosure is environmentally stable at elevated temperature and humidity. The temperature and humidity stability of the stack is due to the inherent stability of the materials used, the compatibility of the materials properties of the layers and the added adhesion and barrier layers.

According to some embodiments consistent with FIGS. 1, 8, 10, and 12 an LP structure as disclosed herein may be applied on the surface of a window, to protect occupants in the interior of a building or vehicle. For example, a structure such as LP structure 100, 800, 1000, 1200 may be applied on the surface of an aircraft window or canopy, or a windshield window in a vehicle. Further embodiments may include LP structures such as 100, 800, 1000, and or 1200 placed on the surface of hospital windows, or a police headquarters or station.

In some embodiments, LP structures consistent with FIGS. 1, 8, 10, and 12 are used to protect a mechanical or electronic device from certain types of radiation. For example, integrated circuits employed in outer-space operations may use LP structures as disclosed herein in order to protect the device from UV radiation. Likewise, UV protecting windows and enclosures using LP structures as disclosed herein may be fabricated to protect vehicle interiors from the deteriorating effect of solar UV radiation as well as laser radiation.

Embodiments of the invention described above are exemplary only. One skilled in the art may recognize various alternative embodiments from those specifically disclosed. Those alternative embodiments are also intended to be within the scope of this disclosure. As such, the invention is limited only by the following claims.

What is claimed is:

1. An optically transmissive structure for laser protection, comprising:
a plurality of metallic layers of material;
a plurality of dielectric layers of material; wherein
the metallic layers of material are interposed with the dielectric layers of material;
the plurality of metallic layers comprises layers each having a thickness smaller than a skin depth of the metallic material at a selected wavelength; and
the plurality of dielectric layers separating two metallic layers comprises layers each having a thickness equal to or smaller than the selected wavelength in the dielectric layer of material.

2. The structure of claim 1 further including substrate to provide support to the pluralities of metallic and dielectric layers.

3. The structure of claim 2 wherein the substrate is transparent at the selected wavelength.

4. The structure of claim 1 wherein the selected wavelength is any wavelength in the visible range.

5. The structure of claim 1 further having an optical density greater than three for wavelengths longer than a second wavelength.

6. The structure of claim 5 wherein the second wavelength is greater than 800 nm.

7. A method for fabricating an optically transmissive structure for laser protection, comprising the steps of:
forming a plurality of metallic layers of material interposed with a plurality of dielectric layers of material on a transparent substrate; wherein
the plurality of metallic layers comprises layers each having a thickness smaller than a skin-depth of the metallic material at a selected wavelength; and
the plurality of dielectric layers separating two metallic layers comprises layers each having a thickness equal to or smaller than the selected wavelength in the dielectric layer of material.

8. A visual-aid device to be used for protection in hazardous environments including high power electromagnetic radiation, comprising:
a support element having a geometry adapted to a user; and
an optically transmissive structure; wherein the optically transmissive structure further comprises:
a plurality of metallic layers of material;
a plurality of dielectric layers of material; wherein
the metallic layers of material are interposed with the dielectric layers of material;
the plurality of metallic layers comprises layers each having a thickness smaller than a skin-depth of the metallic material at a selected wavelength; and
the plurality of dielectric layers separating two metallic layers comprises layers each having a thickness equal to or smaller than the selected wavelength in the dielectric layer of material.

9. The device of claim 8 further comprising a transparent substrate to provide support to the plurality of metallic and dielectric layers.

10. An apparatus, comprising:
a laser protection device that transmits light in the visible wavelength range and provides a high optical density for wavelengths in the near infrared wavelength range, for light having an angle of incidence between zero and sixty degrees relative to normal incidence.

11. The laser protection device of claim 10 further comprising a metal/dielectric multilayered structure having a thickness of less than 500 nm.

12. A multilayered structure for laser protection, comprising:
a first stack of layers comprising metal layers and dielectric layers;
a second stack of layers comprising metal layers and dielectric layers; wherein
the first stack of layers comprises less than seven layers of material, and provides a visible transmittance of less than thirty percent; and
the combination of the first stack of layers and the second stack of layers in an optical path provides a visible transmittance greater than fifty percent and a near infrared optical density greater than two.

13. The structure of claim 12 wherein the second stack of layers has less than 6 layers of material.

14. The structure of claim 12 wherein the metal layers of material comprises layers having a thickness less than the skin depth of the metal material in the visible range.

15. The structure of claim 12 wherein the second stack of layers comprises an aggregated metal thickness of more than 50 nm.

16. A method of forming a multilayered structure for laser protection comprising the steps of:
providing a first stack of layers comprising metal layers and dielectric layers;
providing a second stack of layers comprising metal layers and dielectric layers; wherein
the first stack of layers comprises less than seven layers of material, and provides a visible transmittance of less than thirty percent; and
combining the first stack of layers and the second stack of layers to provide a visible transmittance greater than fifty percent and a near infrared optical density greater than two.

17. An optically transmissive structure for laser protection, comprising:
a plurality of metal layers interposed with dielectric material layers; wherein
a transmittance of the structure is greater than fifty percent (50%) for a first incident light having a wavelength of 550 nm; and
an optical density of the structure is greater than two (2) for a second incident light having a wavelength between 1000 nm and 1400 nm.

18. The optically transmissive structure of claim 17 wherein said transmittance and said optical density change by less than ten percent (10%) for the first and second incident light having an angle of incidence between zero (0) and sixty (60) degrees.

19. The optically transmissive structure of claim 17 wherein a passband of the structure shifts by less than 10 nm as the first incident light changes over an angle of incidence from zero (0) to sixty (60) degrees.

20. An optically transmissive structure for laser protection, comprising:
a means for blocking incident radiation at a wavelength between 1000 nm and 1400 nm; and
a means for transmitting at least fifty percent of incident radiation having a wavelength in the visible range.

21. The optically transmissive structure of claim 20 wherein blocking the incident radiation at a wavelength greater than 1000 nm comprises an optical density greater than two for incident radiation at a wavelength greater than 1000 nm.

22. The optically transmissive structure of claim 20 wherein transmitting incident radiation having a wavelength in the visible range comprises having a passband for wavelengths between 400 nm and 700 nm such that transmission at 550 nm is greater than fifty percent (50%).

23. The optically transmissive structure of claim 20 wherein blocking the incident radiation at a wavelength greater than 1000 nm and transmitting incident radiation having a wavelength in the visible range occurs for radiation having an angle of incidence between zero and sixty degrees.

24. The optically transmissive structure of claim 20 wherein blocking the incident radiation at a wavelength greater than 1000 nm and transmitting incident radiation having a wavelength in the visible range occurs for radiation having any state of polarization.
